(19) United States
(12) Patent Application Publication
(10) Pub. No.: US 2025/0245274 A1
(43) Pub. Date: Jul. 31, 2025

(54) AUTOMATIC ONBOARDING TO A COMPUTER APPLICATION BY SCRAPING WEBSITE DATA

(71) Applicant: INTUIT INC., Mountain View, CA (US)

(72) Inventors: James DUTCZAK, Edmonton (CA); Deepakkumar PRABHAKARAN, Mountain View, CA (US); Jimmy HO, Edmonton (CA); Gopal JAYARAM, Edmonton (CA); Siwei YU, Toronto, Ontario (CA); Alexandra ROHRER, Mountain View, CA (US); Jennifer Lee HONG, Mountain View, CA (US)

(73) Assignee: INTUIT INC., Mountain View, CA (US)

(21) Appl. No.: 18/429,360

(22) Filed: Jan. 31, 2024

(51) Int. Cl. G06F 16/951; G06F 40/20

(52) U.S. Cl. CPC G06F 16/951; G06F 40/20

(57) ABSTRACT

Systems and methods for automating onboarding to a computer application are provided. Onboarding to the computer application is automated by a novel combination of capturing an entity's website, scraping the website for entity data, and using a large language model to extract relevant information. The extracted relevant information is auto-populated on a display. The entity user can update or confirm the displayed information. Therefore, the cognitive strain and inefficiencies associated with switching between computer applications is significantly reduced.

### BACKGROUND

Computer implemented applications have significantly changed business operations over the past few decades. Physical logbooks, journals, ledgers, paper files of receipts and invoices, etc. have given way to computer storage and analysis. While large businesses were early to adopt large computing infrastructures and complex computer applications, computer applications such as QuickBooks® from Intuit® of Mountain View, California have been widely adopted by small businesses. QuickBooks® and similar computer applications automate and simplify tedious and laborious back-end operations. When the routine operations are automated, precious human capital can be rightly used for creative thinking, problem solving, etc.

Onboarding to computer applications is a significant technical problem. Users need to be guided through several different interfaces to collect and integrate information. There are existing solutions on platforms like Wix® or Shopify® that guide new users in setting up their online store using chatbot-like interfaces. But these interfaces are not accurate or comprehensive. This situation is undesirable and a technical solution is therefore needed.

### SUMMARY

Embodiments disclosed herein solve the aforementioned technical problems and may provide other solutions as well. Onboarding to a computer application is automated by a novel combination of capturing an entity's website, scraping the website for entity data, and using a large language model to extract relevant information. The extracted relevant information is auto-populated on a display. The entity user can update or confirm the displayed information. Therefore, the embodiments provide a more accurate and comprehensive onboarding process compared to the conventional solutions.

### BRIEF DESCRIPTION OF THE DRAWINGS

The drawings are presented to illustrate various aspects of the principles disclosed herein. As the purpose is merely illustration, the drawings are not to be considered limiting.

FIG. 1 shows an example of a system configured for onboarding an entity to a computer application, based on the principles disclosed herein.

FIG. 2 shows an example architecture configured for onboarding an entity to a computer application, based on principles disclosed herein.

FIG. 3 is a flow diagram of an example method of onboarding an entity to a computer application, based on the principles disclosed herein.

FIGS. 4A-4C show example interfaces generated during an onboarding of an entity to a computer application, based on the principles disclosed herein.

FIG. 5 shows a block diagram of an example computing device that implements various features and processes, based on the principles disclosed herein.

### DETAILED DESCRIPTION OF SEVERAL EMBODIMENTS

Embodiments disclosed herein provide a more comprehensive and accurate onboarding to a new computer application. The disclosed systems and methods prompt the entity user to input the identification of the entity's website. At the back-end, a scraper automatically scrapes data from the website. A large language model is deployed on the scraped data to extract relevant information. The relevant information is auto-populated on a user interface such that the entity user can simply confirm or update the displayed information.

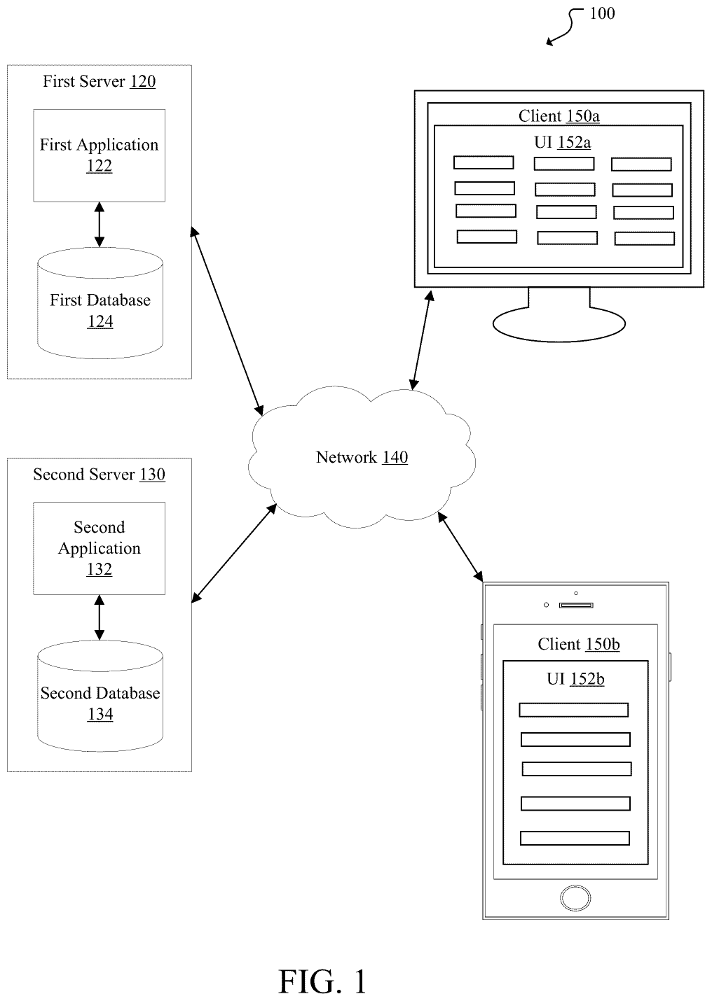

FIG. 1 shows an example of a system 100 configured for onboarding an entity to a computer application, based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b (collectively referred to herein as “client devices 150”), and first and second servers 120, 130 interconnected by a network 140. The first server 120 hosts a first server application 122 and a first database 124 and the second server 130 hosts a second server application 132 and a second database 134. The client devices 150a, 150b have user interfaces 152a, 152b, respectively (collectively referred to herein as “user interfaces (UIs) 152”), which may be used to communicate with the server applications 122, 132 via the network 140.

The server applications 122, 132 implement the various operations disclosed throughout this disclosure. In one or more embodiments, the server applications 122, 132 comprise the computer applications that that entity is being onboarded to. To that end, the server applications 122, 132 prompt, on the user interfaces 152a, 152b, the entity user to enter a universal resource locator (URL) and/or any other type of source address of the entity's website. The server applications 122, 132 then execute a scraper to scrape data from the URL (and/or any other type of source). The scraped data may be stored in the databases 124, 134. The server applications 122, 132 use one or more large language models on the scraped data to extract relevant information. The extracted relevant information is displayed on the user interfaces 152a, 152b for the entity user to confirm or update the displayed information. In or more embodiments, the extracted relevant information may be stored in the databases 124, 134 and displayed later. When the entity user confirms or updates the displayed information, the server applications 122, 132 perform other downstream operations required to complete the onboarding.

In addition to the data for the operations to be performed, the databases 124, 134 may further store the programming scripts required to implement the principles disclosed herein. For example, the databases 124, 134 can store instructions for executing the corresponding server applications 122, 132. It should be understood that the databases 124, 134 may be implemented in any form, including, but not limited to, a relational database, an object-oriented database, a distributed database, and/or any other form of database.

Client devices 150 may include any device configured to present the user UIs 152 and receive user inputs through the UIs. The UIs 152 can be graphical user interfaces or command line interfaces. Regardless of the type of the UIs 152, they provide a window or any type of location for the users to provide their inputs. The inputs include, for example, the URL of the entity being onboarded, updates to displayed information, and/or the like.

Communication between the different components of the system 100 is facilitated by one or more APIs. APIs of system 100 may be proprietary and or may include APIs such as AWS APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

First server 120, second server 130, first database 124, second database 134, and client devices 150 are each depicted as single devices for ease of illustration, but those of ordinary skill in the art will appreciate that first server 120, second server 130, first database 124, second database 134, and/or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one) servers. In another example, a plurality of client devices 150 may communicate with first server 120 and/or second server 130. A single user may have multiple client devices 150, and/or there may be multiple users each having their own client devices 150.

Furthermore, it should be understood that the illustrated applications 122, 132 running on the servers 120, 130, and the databases 124, 134 being hosted by the servers 120, 130 are examples for carrying out the disclosed principles and should not be considered limiting. Different portions of the server applications 122, 132 and, in one or more embodiments, the entirety of the server applications 122, 132 can be stored in the client devices 150. Similarly, different portions or even the entirety of the databases 124, 134 can be stored in the client devices 150. Therefore, the functionality described throughout this disclosure can be implemented at any portion of the system 100.

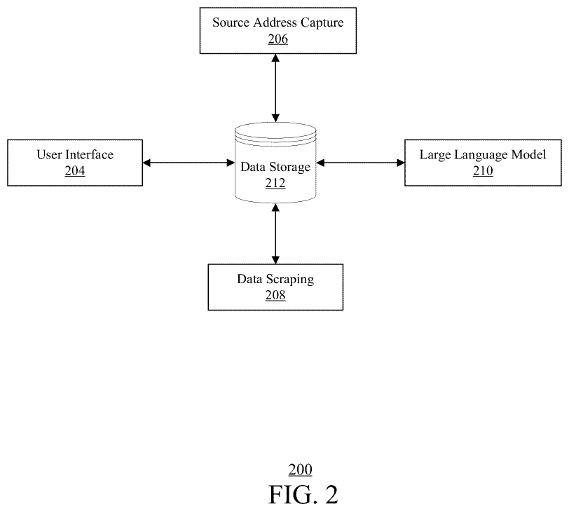

FIG. 2 shows an example architecture 200 configured for onboarding an entity to a computer application, based on principles disclosed herein. It should be understood that the components of the architecture 200 are just examples and should not be considered limiting. That is, architectures with additional, alternative, or fewer number of components should be considered within the scope of this disclosure. The architecture 200 can be implemented by any combination of components in the system 100 shown in FIG. 1.

As shown, the architecture 200 includes a user interface module 204, a source address capture module 206, a data scraping module 208, a large language model 210, and a data storage 212. Each of these components can be implemented using any combination of hardware and software on any type of network. For example, these components can be implemented using a client-server model with different portions of components (e.g., the user interface module 204) residing on the client side and other portions of the components (e.g., the large language model 210) residing on the server side.

The user interface module 204 is configured to capture information about an entity being onboarded. The user interface module 204 is additionally configured for an entity user to interact with information displayed on the user interface. For example, the user interface module 204 allows the entity user to enter a source address for the entity, where the source address may be a URL to the entity's website. After other modules (e.g., the website scraping module 208) gathers information from the website, the user interface module 204 displays the information and allows the entity user to interact with displayed information, e.g., to update or confirm the displayed information. The user interface module 204 further interfaces with the large language model 210 such that the entity user leverages the large language model 210 to extract relevant information from the scraped data.

The source address capture module 206 is configured to capture the source address of the information to be collected. For example, the source address capture module 206 may capture the URL of the entity's website. As alternatives to URLs, the source address capture module 206 can capture an address of a file system (remote or local), data repository, and/or the like. Generally, any kind of electronic address for a source of the information should be considered within the scope of this disclosure. In one or more embodiments, the entity user is prompted to enter the source address into the user interface module 204, e.g., by typing the source address on a window rendered by the user interface module 204.

The data scraping module 208 is configured to scrape data from the source address captured by the source address capture module 206. In the embodiments where the source address is a URL, the data scaping module 208 is a website scraper. The website scraper takes in the URL, navigates to the website, and scrapes the information from the website. Non-limiting examples of suitable website scrapers include ScrepeThisSite®, Selenium®, Content Grabber®, ScrapingBee®, ParseHub®, WebHarvy®, or the like. Data scraped by the information scraping module 208 is stored in the data storage 212.

The large language model 210 is configured to discern and extract specific information from the data scraped by the data scraping module 208. Non-limiting examples of suitable large language model 210 include GPT-3.5 (OpenAIR), GPT-4 (OpenAIR), ChatGPT (OpenAIR), PaLM (Google®), LLaMa (Meta®), BLOOM, Ernie 3.0 Titan, and/or Claude, to name a few. The specific information extracted by the large language model 210 includes a description of the entity, an industry type, a tax specification, workforce size, an operational tenure, and/or the like. In one or more embodiments, the large language model 210 allows prompt engineering for the entity user to extract a particular type of entity information (e.g., market share).

In one or more embodiments, the large language model 210 is fine tuned to extract the entity specific information. The fine tuning is based on data of similar entities where essential information required for the onboarding is labeled. The large language model 210 therefore learns to identify the essential information, thereby increasing both the accuracy and comprehensiveness of the onboarding process.

In one or more embodiments, the fine tuned large language model 210 is used for data synthesis functionality. Data synthesis not only extracts a comprehensive amount of data, but also discerns and identifies essential business information. The essential business information can be auto-populated by the user interface module 204 such that the entity user can perform a validation of the scraped data. The validated data can then be integrated into the computer application. Other non-essential information can be stored by the data storage 212 for future reference. Such validation and integration increases the accuracy of the onboarding process.

The data storage 212 stores data generated and/or used by the other components of the architecture 200. For example, the data storage 212 stores the source address captured by the source address capture module 206, data extracted by the data scraping module 208, and/or information extracted by the large language model 210. However, any other type of data stored and/or used by the different components should be considered within the scope of this disclosure.

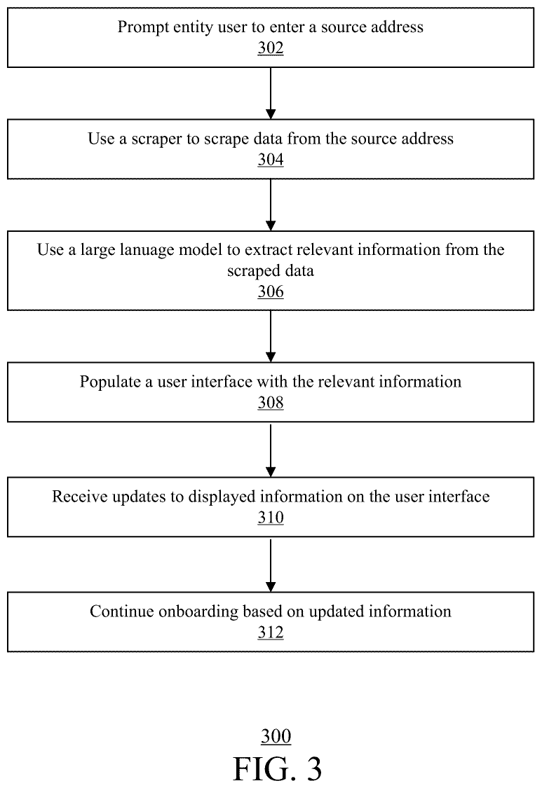

FIG. 3 is a flow diagram of an example method 300 of onboarding an entity to a computer application, based on the principles disclosed herein. It should be understood that the steps of the method 300 are merely examples and should not be considered limiting. That is, methods with additional, alternative, or fewer number of steps should be considered within the scope of this disclosure. The steps of the method 300 can be performed by any combination of the components in the system 100 and/or the architecture 200. In one or more embodiments, the computer application includes QuickBooks® from Intuit® of Mountain View, California.

The method begins at step 302, where an entity user is prompted (e.g., by the user interface module 204) to enter a source address via a user interface (e.g., UI 152a, UI 152b of FIG. 1). In one or more embodiments, step 302 is performed by the source address capture module 206. The entity user is associated with an entity being onboarded to the computer application. The entity may be a business that is switching from another computer application (e.g., from another vendor) to the computer application. In one or more embodiments, the source address includes a URL of the website of the business.

At step 304, a scraper is used to scrape data from the source address. In one or more embodiments, step 304 is performed by data scraping module 208. In the embodiments where the source address is a URL, a web scraper is used to scrape data from the corresponding website. The scraped data may therefore include relevant information about the entity being onboarded to the computer application.

At step 306, a large language model (e.g., large language module 210) is used to extract relevant information from the scraped data. For instance, the large language model may parse—e.g., through natural language processing—the relevant information from the scraped data. Alternatively or additionally, specialized prompts may be used to extract business specific information. The specialized prompts may go above and beyond the natural language processing (e.g., to extract a name of the entity) and extract specific information such as the entity's number of employees, market share, geographical markets, and/or the like.

At step 308, the user interface is automatically populated with the extracted relevant information. That is, the user interface shows the extracted information for the entity user to verify and/or edit. In conventional systems, the displayed information would be manually entered by the entity user, whereas the embodiments disclosed herein automatically populate the information, thereby significantly improving the efficiency of the onboarding process.

At step 310, updates to the displayed information on the user interface are received. For instance, the entity user may manually verify the displayed information and enter updates, if needed. The updates are used to update the displayed information and the information stored in the database.

At step 312, the onboarding process may be continued based on any updated information. That is, the updated information may be stored as a valid record in the database. The valid record is used for downstream operations that require the relevant records such that that entity is onboarded to the computer application.

In one or more embodiments, the entity user uploads a local file, from which additional information can be extracted. The local file may include, for example, a locally stored database about the entity, e.g., an Excel file with the name and addresses of the employees. The extracted additional information is displayed to the entity user to update or confirm.

In one or more embodiments, the displayed information is augmented based on previous information stored in a database. The previous information may include, for example, additional information from prior onboarding sessions of similar entities, general historical information known to the system 100, and/or the like.

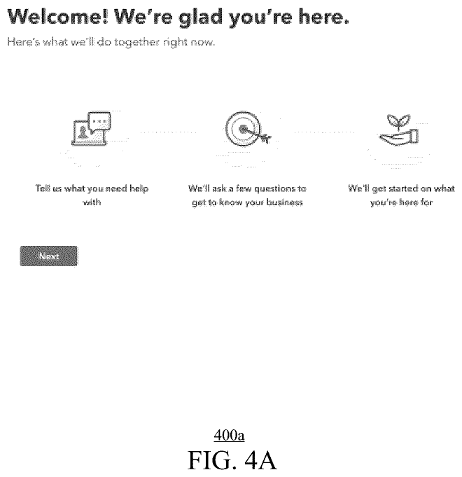

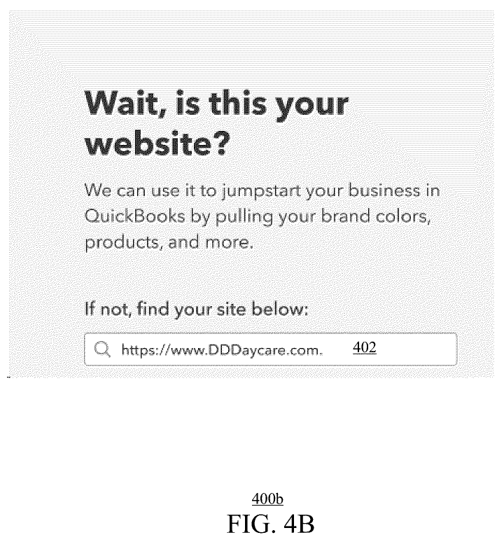

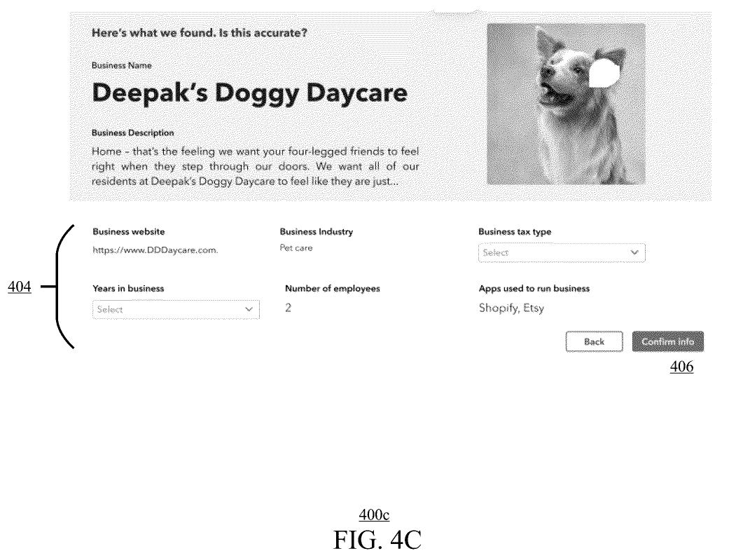

FIGS. 4A-4C show example interfaces 400a-400c generated during an onboarding of an entity to a computer application, based on the principles disclosed herein. It should be understood that the interfaces and components therein are merely intended as examples and should not be considered limiting. That is, interfaces with additional, alternative or fewer number of components should be considered within the scope of this disclosure.

FIG. 4A shows the interface 400a that welcomes an entity user to initiate the onboarding process. FIG. 4B shows an updated interface 400b with a window 402 configured to capture an entity's website. FIG. 4C shows another updated interface 400c that displays the extracted information 404. The entity user can edit the extracted information 404 or confirm the extracted information using a selector button 406.

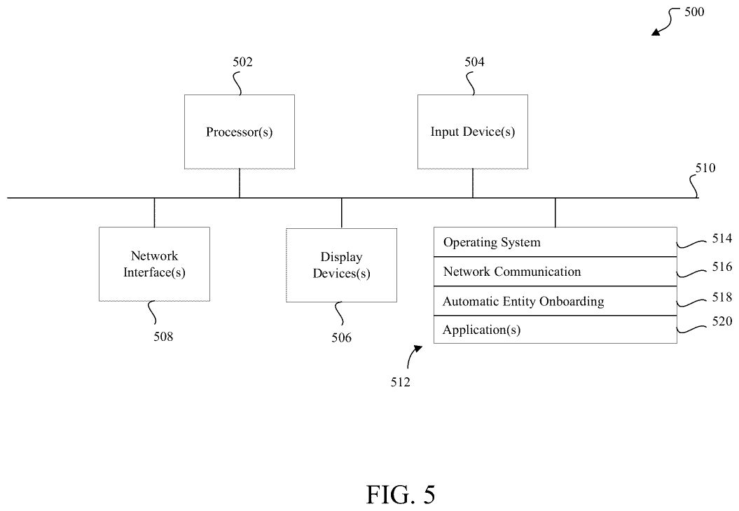

FIG. 5 shows a block diagram of an example computing device 500 that implements various features and processes, based on the principles disclosed herein. For example, computing device 500 may function as first server 120, second server 130, client device 150a, client device 150b, or a portion or combination thereof in some embodiments. The computing device 500 may form one or more portions of the architecture 200. The computing device 500 may perform one or more steps of the method 300. The computing device 500 is implemented on any electronic device that runs software applications derived from compiled instructions, including without limitation personal computers, servers, smart phones, media players, electronic tablets, game consoles, email devices, etc. In one or more embodiments, the computing device 500 includes one or more processors 502, one or more input devices 504, one or more display devices 506, one or more network interfaces 508, and one or more computer-readable media 512. Each of these components is be coupled by a bus 510.

Display device 506 includes any display technology, including but not limited to display devices using Liquid Crystal Display (LCD) or Light Emitting Diode (LED) technology. Processor(s) 502 uses any processor technology, including but not limited to graphics processors and multi-core processors. Input device 504 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 512 includes any non-transitory computer readable medium that provides instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 includes various instructions 514 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 504; sending output to display device 506; keeping track of files and directories on computer-readable medium 512; controlling peripheral devices (e.g., disk drives, printers, etc.) which can be controlled directly or through an I/O controller; and managing traffic on bus 510. Network communications instructions 516 establish and maintain network connections (e.g., software for implementing communication protocols, such as TCP/IP, HTTP, Ethernet, telephony, etc.).

Automatic entity onboarding module 518 includes instructions that implement the disclosed embodiments for automatically onboarding an entity to a computer application.

Application(s) 520 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A computer-implemented method of automatic onboarding of an entity to a computer application on a client computer, the method comprising:
rendering, by a server computer, a user interface on the client computer for an entity user to enter an entity's universal resource locator (URL);
receiving, by the server computer, a URL entered via the user interface;
scraping, by the server computer, entity data from the URL using a website scraper;
extracting, by the server computer, entity information using a large language model on the scraped entity data;
receiving, by the server computer from the client computer, a local file;
extracting, by the server computer, a second entity information from the local file; and
auto-populating, by the server computer, the extracted entity information and the extracted second entity information on an interface of the computer application.

2. The computer-implemented method of claim 1, further comprising:
receiving, by a server computer, updates to the auto-populated extracted entity information; and
updating, by a server computer, the auto-populated extracted entity information with the received updates.

3. The computer-implemented method of claim 1, the auto-populating the extracted entity information comprises:
auto-populating, by a server computer, business information of the entity on the interface of the computer application.

4. The computer-implemented method of claim 1, further comprising:
augmenting, by a server computer, the auto-populated entity information with additional information stored in a database.

5. The computer-implemented method of claim 1, the using the large language model comprising:
using, by a server computer, specific prompts for the large language model to extract the entity information.

6. The computer-implemented method of claim 1, further comprising:
storing, by a server computer, the extracted entity information on a data storage; and
auto-populating, by a server computer, the interface of the computer application using the stored extracted entity information.

7. (canceled)

8. A system comprising:
a non-transitory storage medium storing computer program instructions; and
a processor in a server computer and configured to execute the computer program instructions to cause the server computer to perform operations comprising:
rendering a user interface on a client computer for an entity user to enter an entity's universal resource locator (URL);
receiving an URL entered on the user interface;
scraping entity data from URL using a website scraper;
extracting entity information using a large language model on the scraped entity data;
receiving a local file from the client computer;
extracting a second entity information from the local file; and
auto-populating the extracted entity information and the extracted second entity information on an interface of a computer application on the client computer.

9. The system of claim 8, the operations further comprising:
receiving updates to the auto-populated extracted entity information; and
updating the auto-populated extracted entity information with the received updates.

10. The system of claim 8, the auto-populating the extracted entity information comprises:
auto-populating business information of the entity business on the interface of the computer application.

11. The system of claim 8, the operations further comprising:
augmenting the auto-populated entity information with additional information stored in a database.

12. The system of claim 8, the using the large language model comprising:
using specific prompts for the large language model to extract the entity information.

13. The system of claim 8, the operations further comprising:
storing the extracted entity information on a data storage; and
auto-populating the interface of the computer application using the stored extracted entity information.

14. (canceled)

15. A non-transitory storage medium storing computer program instructions that when executed by a processor in a server computer cause operations:
rendering a user interface on a client computer for an entity user to enter an entity's universal resource locator (URL);
receiving an URL entered on the user interface;
scraping entity data from URL using a website scraper;
extracting entity information using a large language model on the scraped entity data;
receiving a local file from the client computer;
extracting a second entity information from the local file; and
auto-populating the extracted entity information and the extracted second entity information on an interface of a computer application on the client computer.

16. The non-transitory storage medium of claim 15, the operations further comprising:
receiving updates to auto-populated extracted entity information; and
updating the auto-populated extracted entity information with the received updates.

17. The non-transitory storage medium of claim 15, the auto-populating the extracted entity information comprises:
auto-populating business information of the entity on the interface of the computer application.

18. The non-transitory storage medium of claim 15, the operations further comprising:
augmenting the auto-populated entity information with additional information stored in a database.

19. The non-transitory storage medium of claim 15, the using the large language model comprising:
using specific prompts for the large language model to extract the entity information.

20. The non-transitory storage medium of claim 15, the operations further comprising:
storing the extracted entity information on a data storage; and
auto-populating the interface of the computer application using the stored extracted entity information.
